(19) United States
(12) Patent Application Publication
(10) Pub. No.: US 2015/0254795 A1
(43) Pub. Date: Sep. 10, 2015

(54) Automated Estate Management

(71) Applicant: ESTATE ASSIST, INC., San Francisco, CA (US)

(72) Inventors: Woodrow H. Levin, San Francisco, CA (US); Joseph G. Moss, Danville, CA (US)

(73) Assignee: ESTATE ASSIST, INC., San Francisco (AF)

(21) Appl. No.: 14/329,173

(22) Filed: Jul. 11, 2014

Related U.S. Application Data
(60) Provisional application No. 61/949,900, filed on Mar. 7, 2014.

(51) Int. Cl. G06Q 50/18; G06F 21/62

(52) U.S. Cl. CPC G06Q 50/186; G06F 21/6245

(57) ABSTRACT

Systems and methods for automated estate management. Estate data for an estate is received. Allowable entities authorized to access the estate data are determined. Portions of the estate data that the entities are allowed to access are determined. At least one access condition that needs to be met in order to allow the entities to access the portions of the estate data are determined. Whether the at least one access condition is met is determined. Access is provided for the entities to the portions of the estate data that the entities are authorized to access if it is determined that the at least one access condition is met.

### CROSS-REFERENCE TO RELATED APPLICATIONS

This application claims priority to U.S. Provisional Patent Application No. 61/949,900, filed Mar. 7, 2014, entitled “ESTATE MANAGEMENT,” which is incorporated by reference.

### BACKGROUND

An area of ongoing research and development is the management of estates. Specifically, in managing estates, an executor of an estate has to search for accounts associated with an estate, documents associated with an estate and manage the estate accordingly. Often times it can be difficult for the executor of an estate to locate estate accounts and documents associated with an estate. There therefore exists the need for systems and methods to allow an executor or any entity associated with an estate to receive estate data that includes estate accounts and documents associated with an estate when a person that is the subject of an estate dies or becomes incapacitated.

Other limitations of the relevant art will become apparent to those of skill in the art upon a reading of the specification and a study of the drawings.

### SUMMARY

The following implementations and aspects thereof are described and illustrated in conjunction with systems, tools, and methods that are meant to be exemplary and illustrative, not necessarily limiting in scope. In various implementations one or more of the above-described problems have been addressed, while other implementations are directed to other improvements.

Various implementations include systems and methods for automated estate management. In various implementations, estate data for an estate is received. Additionally, in various implementations, allowable entities authorized to access the estate data are determined. In various implementations, portions of the estate data that the entities are allowed to access are determined. Further, in various implementations, at least one access condition that needs to be met in order to allow the entities to access the portions of the estate data are determined. In various implementations, whether the at least one access condition is met is determined. Additionally, in various implementations, access is provided for the entities to the portions of the estate data that the entities are authorized to access if it is determined that the at least one access condition is met.

These and other advantages will become apparent to those skilled in the relevant art upon a reading of the following descriptions and a study of the several examples of the drawings.

### BRIEF DESCRIPTION OF THE DRAWINGS

FIG. 1 depicts a diagram of an example of a system for managing an estate.

FIG. 2 depicts a diagram of an example of a system for performing automated estate account management.

FIG. 3 depicts a diagram of an example of a system for enrolling an entity in an automated estate management system.

FIG. 4 depicts a diagram of an example of a system for managing estate accounts associated with an estate.

FIG. 5 depicts a diagram of an example of a system for managing estate documents of an estate.

FIG. 6 depicts a diagram of an example of a system for managing access to estate data through an estate management system.

FIG. 7 depicts a flowchart of an example of a method for managing access to estate data.

FIG. 8 depicts a flowchart of an example of a method for providing access to estate account data of a discovered estate account of an estate.

FIG. 9 depicts a flowchart of an example of a method for providing access to estate account data of an estate account of an estate discovered using a financial account of a person that is the subject of the estate.

FIG. 10 depicts a flowchart of an example of a method for generating access data used in managing access to estate data.

FIG. 11 depicts a flowchart of an example of a method for providing access to estate account data of a discovered estate document of an estate.

### DETAILED DESCRIPTION

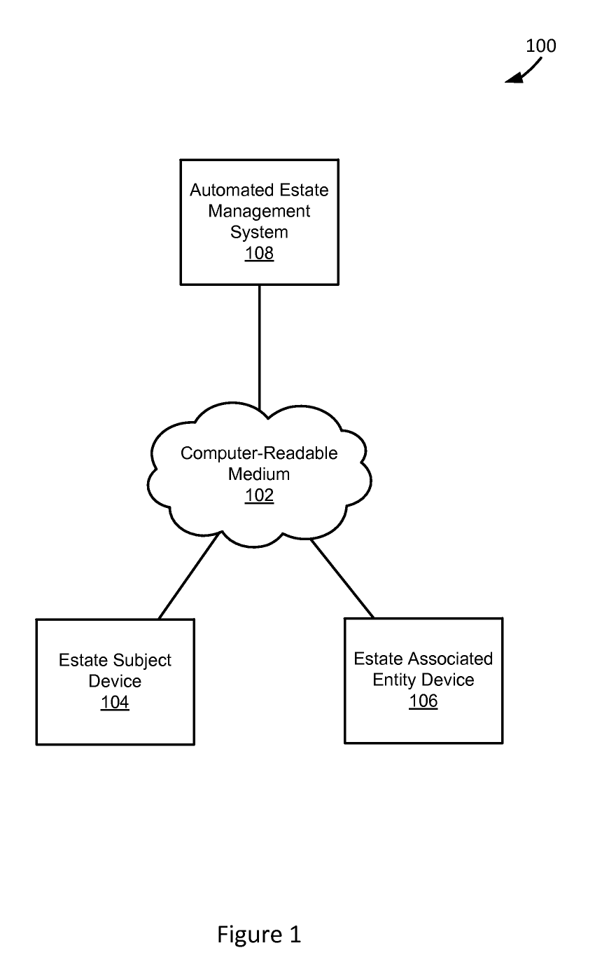

FIG. 1 depicts a diagram 100 of an example of a system for managing an estate. The system of the example of FIG. 1 includes a computer-readable medium 102, an estate subject device 104, an estate associated entity device 106, and an automated estate management system 108.

The estate subject device 104, the estate associated entity device 106, and the automated estate management system 108 are coupled to each other through the computer-readable medium 102. As used in this paper, a “computer-readable medium” is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer-readable medium 102 is intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a wireless or wired back-end network or LAN. The computer-readable medium 102 can also encompass a relevant portion of a WAN or other network, if applicable.

The computer-readable medium 102, the estate subject device 105, the estate associated entity device 106, the automated estate management system 108, and other applicable systems, or devices described in this paper can be implemented as a computer system, a plurality of computer systems, or parts of a computer system or a plurality of computer systems. A computer system, as used in this paper, is intended to be construed broadly. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine, or through multiple engines. As used in this paper, an engine includes at least two components: 1) a dedicated or shared processor and 2) hardware, firmware, and/or software modules that are executed by the processor. Depending upon implementation-specific or other considerations, an engine can be centralized or its functionality distributed. An engine can include special purpose hardware, firmware, or software embodied in a computer-readable medium for execution by the processor. The processor transforms data into new data using implemented data structures and methods, such as is described with reference to the FIGs. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

In a specific implementation, the estate subject device 104 functions to allow a person that is the subject of an estate to send and receive data used in the management of the estate. Depending upon implementation-specific or other considerations, the estate subject device 104 can include a wireless interface, through which the estate subject device 104 can be coupled to the computer-readable medium 102 and subsequently other devices, systems or engines coupled to the computer-readable medium 102, through a wireless connection. Further depending upon implementation-specific or other considerations, the estate subject device 104 can be a thin client device, or an ultra-thin client device. The estate subject device 104 can be used to send estate data from a person that is the subject of an estate. Estate data can include estate accounts data and estate documents data. Estate accounts, as used in this paper, include accounts associated with an estate, e.g. an account held by a person that is the subject of an estate. Estate documents, as used in this paper, include documents associated with an estate, e.g. a power of attorney or a will for the estate. Estate data can also include personal data of either or both a person that is the subject of an estate and a person associated with the person that is the subject of the estate. A person associated with a person that is the subject of an estate can include a spouse of a person that is the subject of the estate, a child of the person that is the subject of an estate, and a relative of a person that is the subject of the estate. Personal data, as is used in this paper can include any applicable information used to identify, characterize, or otherwise describe a person, including a gender, a date of birth, an address, a zip code, and a social security number.

In a specific implementation, the estate associated entity device 106 functions to allow an entity associated with an estate to send and receive data used in the management of the estate. Depending upon implementation-specific or other considerations, the estate associated entity device 106 can include a wireless interface, through which the estate associated entity device 106 can be coupled to the computer-readable medium 102 and subsequently other devices, systems or engines coupled to the computer-readable medium 102, through a wireless connection. Further depending upon implementation-specific or other considerations, the estate associated entity device 106 can be a thin client device, or an ultra-thin client device. The estate associated entity device 106 can be used to send estate data from an entity associated with an estate.

In a specific implementation, the automated estate management system 108 functions to provide automated management of an estate. Depending upon implementation-specific or other considerations, in providing automated management of an estate, the automated estate management system 108 can receive estate data for the estate. Further depending upon implementation-specific or other considerations, in providing automated management of an estate, the automated estate management system 108 can manage access to estate data for the estate. Depending upon implementation-specific or other considerations, the estate associated entity device 106 can be the same device as the estate subject device 104.

In a specific implementation, the automated estate management system 108 functions to enroll an entity. Depending upon implementation-specific or other considerations, the automated estate management system 108 can enroll a person that is the subject of an estate or an entity associated with an estate. For example, the automated estate management system 108 can enroll a person that is a beneficiary, or an executor of an estate. In enrolling an entity, the automated estate management system 108 can function to receive payment information and verify whether en entity, including a person that is the subject of an estate, has paid for services offered by the automated estate management system 108. Additionally, in enrolling an entity, the automated estate management system 108 can function to receive and/or generate access data. Depending upon implementation-specific or other considerations, access data received and/or generated by the automated estate management system 108 can be used to determine an entity to grant access to estate data, what estate data to grant access to, and when to grant an entity access to the estate data.

In a specific implementation, the automated estate management system 108 functions to manage estate accounts of an estate. In managing estate accounts, the automated estate management system 108 can receive estate account data, included as part of estate data. Estate account data can include data identifying an account of a person that is the subject of an estate. For example, estate account data can identify an account identification number of an account associated with an estate, and/or login information used by an account holder to login to the account associated with the estate. Additionally, in managing estate accounts, the automated estate management system 108 can discover accounts a person associated with an estate might hold. Depending upon implementation-specific or other considerations, the estate automated estate management system 108 can discover accounts a person associated with an estate might hold based on a region associated with the person associated with the estate.

In a specific implementation, the automated estate management system 108 functions to manage estate documents associated with an estate. In managing estate documents, the automated estate management system 108 can receive estate documents associated with an estate, included as part of estate data for the estate. Estate documents associated with an estate can include applicable documents associated with an estate, such as a testamentary device and a death certificate. Depending upon implementation-specific or other considerations, in managing estate documents associated with an estate, the automated estate management system 108 can receive estate documents from either or both a person that is the subject of an estate or an entity associated with the estate. For example, the automated estate management system 108 can receive a death certificate of a person that is the subject of an estate from an entity associated with the estate. In managing estate documents associated with an estate, the automated estate management system 108 can function to discover estate documents associated with an estate. For example, the automated estate management system 108 can discover a will for an estate from public records available through a public records system.

In a specific implementation, the automated estate management system 108 functions to manage access to estate data. Depending upon implementation-specific or other considerations, in managing access to estate data, the automated estate management system 108 can either or both, allow an entity to access the estate data, or send the estate data to an entity. In managing access to estate data, the automated estate management system 108 can determine which entities are allowed to access which estate data and what access conditions must be met before an entity can be allowed to access estate data. Depending upon implementation-specific or other considerations, the automated estate management system 108 can determine which entities are allowed to access which estate data, and what access conditions must be met before an entity can be allowed to access estate data based on access data. For example, access conditions determined from access data can specify to grant access to an entity if login information received from the entity is verified to be correct, as determined by looking up the entity and associated login information in the access data. Access data used by the automated estate management system 108 to determine which entities are allowed to access which estate data, and what access conditions must be met before an entity can be allowed to access estate data can be received from either or both a person that is the subject of an estate or an entity associated with an estate. For example, an executor of an estate can determine what entities associated with an estate are allowed to access estate data of the estate.

In an example of operation of the example system shown in FIG. 1, the automated estate management system receives estate data for an estate from either or both the estate subject device 104 and the estate associated entity device 106. In the example of operation of the example system shown in FIG. 1, the automated estate management system 108 determines access conditions for an entity used to determine whether the entity can access the received estate data.

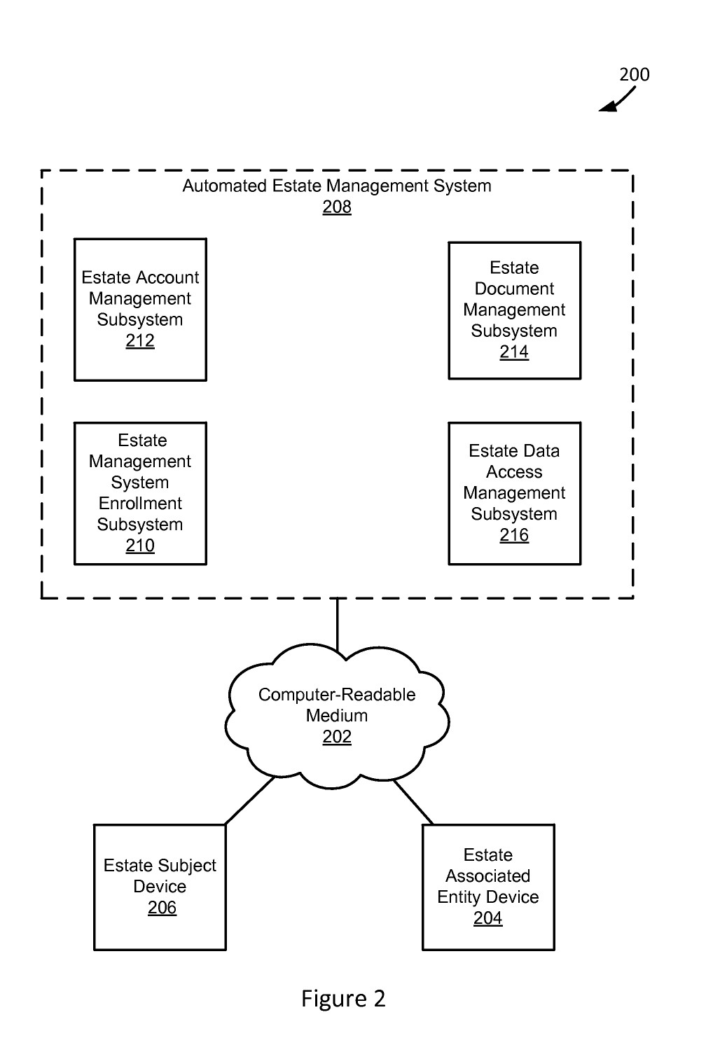

FIG. 2 depicts a diagram 200 of an example of a system for performing automated estate account management. The example system shown in FIG. 2, includes a computer-readable medium 202, an estate associated entity device 204, an estate subject device 206, and an automated estate management system 208. In the example system shown in FIG. 2, the estate associated entity device 204, the estate subject device 206, and the automated estate management system 208 are coupled to each other through the computer-readable medium 202.

In a specific implementation, the estate associated entity device 204 functions according to an applicable device of an entity associated with an estate, such as the estate associated entity devices described in this paper. Depending upon implementation-specific or other considerations, the estate associated entity device 204 can include a wireless interface, though which the estate associated entity device 204 can be coupled to the computer-readable medium 202, and subsequently other devices, systems or engines coupled to the computer-readable medium 202, through a wireless connection. Further depending upon implementation-specific or other considerations, the estate associated entity device 204 can be a thin client device, or an ultra-thin client device.

In a specific implementation, the estate subject device 206 functions according to an applicable device of a subject of an estate, such as the estate subject devices described in this paper. Depending upon implementation-specific or other considerations, the estate subject device 206 can include a wireless interface, through which the estate subject device 206 can be coupled to the computer-readable medium 202 and subsequently other devices, systems or engines coupled to the computer-readable medium 202, through a wireless connection. Further depending upon implementation-specific or other considerations, the estate subject device 206 can be a thin client device, or an ultra-thin client device.

In a specific implementation, the automated estate management system 208 functions according to an applicable system for managing an estate through an automated fashion, such as the automated estate management systems described in this paper. The automated estate management system 208 can function to enroll a person that is the subject of an estate to utilize services provided by the automated estate management system 208. Depending upon implementation-specific or other considerations, in enrolling a person that is the subject of an estate, the automated estate management system 208 can receive and/or generate access data. The automated estate management system 208 can function to manage estate account data of an estate. The automated estate management system 208 can also function to manage estate documents of a person that is the subject of an estate. Additionally, the automated estate management system 208 can function to manage access to estate data, including either or both estate account data and estate documents of an estate. Depending upon implementation-specific or other considerations, in managing access to estate data, the automated estate management system 208 can use account data to determine an entity to grant access to estate data, what estate data to grant access to, and when to grant an entity access to the estate data.

In the example system shown in FIG. 2, the automated estate management system 208 includes an estate management system enrollment subsystem 210, an estate account management subsystem 212, an estate document management subsystem 214, and an estate data access management subsystem 216. In a specific implementation, the estate management system enrollment subsystem 210 functions to enroll an entity with the automated estate management system 208. Depending upon implementation-specific or other considerations, the estate management system enrollment subsystem 210 can enroll a person that is the subject of an estate or an entity associated with an estate. For example, the estate management system enrollment subsystem 210 can enroll a person that is a beneficiary, or an executor of an estate. In enrolling an entity, the estate management system enrollment subsystem 210 can function to receive payment information and verify whether en entity, including a person that is the subject of an estate, has paid for services offered by the automated estate management system 208. Additionally, in enrolling an entity, the estate management system enrollment subsystem 210 can function to receive and/or generate access data. Depending upon implementation-specific or other considerations, access data received and/or generated by the estate management system enrollment subsystem 210 can be used to determine an entity to grant access to estate data, what estate data to grant access to, and when to grant an entity access to the estate data.

In a specific implementation, the estate account management subsystem 212 functions to manage estate accounts of an estate. In managing estate accounts, the estate account management subsystem 212 can receive estate account data, included as part of estate data. Estate account data can include data identifying an account of a person that is the subject of an estate. For example, estate account data can identify an account identification number of an account associated with an estate, and/or login information used by an account holder to login to the account associated with the estate. Additionally, in managing estate accounts, the estate account management subsystem 212 can discover accounts a person associated with an estate might hold. Depending upon implementation-specific or other considerations, the estate account management subsystem 212 can discover accounts a person associated with an estate might hold based on a region associated with the person associated with the estate.

In a specific implementation, the estate document management subsystem 214 functions to manage estate documents associated with an estate. In managing estate documents, the estate document management subsystem 214 can receive estate documents associated with an estate, included as part of estate data for the estate. Estate documents associated with an estate can include applicable documents associated with an estate, such as a testamentary device and a death certificate. Depending upon implementation-specific or other considerations, in managing estate documents associated with an estate, the estate document management subsystem 214 can receive estate documents from either or both a person that is the subject of an estate or an entity associated with the estate. For example, the estate document management subsystem 214 can receive a death certificate of a person that is the subject of an estate from an entity associated with the estate. In managing estate documents associated with an estate, the estate document management subsystem 214 can function to discover estate documents associated with an estate. For example, the estate document management subsystem 214 can discover a will for an estate from public records available through a public records system.

In a specific implementation, the estate data access management subsystem 216 functions to manage access to estate data. Depending upon implementation-specific or other considerations, in managing access to estate data, the estate data access management subsystem 216 can either or both, allow an entity to access the estate data, or send the estate data to an entity. In managing access to estate data, the estate data access management subsystem 216 can determine which entities are allowed to access which estate data and what access conditions must be met before an entity can be allowed to access estate data. Depending upon implementation-specific or other considerations, the estate data access management subsystem 216 can determine which entities are allowed to access which estate data, and what access conditions must be met before an entity can be allowed to access estate data based on access data. For example, access conditions determined from access data can specify to grant access to an entity if login information received from the entity is verified to be correct, as determined by looking up the entity and associated login information in the access data. Access data used by the estate data access management subsystem 216 to determine which entities are allowed to access which estate data, and what access conditions must be met before an entity can be allowed to access estate data can be received from either or both a person that is the subject of an estate or an entity associated with an estate. For example, an executor of an estate can determine what entities associated with an estate are allowed to access estate data of the estate.

In an example of operation of the example system shown in FIG. 2, the estate management system enrollment subsystem 210 enrolls a user associated with an estate, including either or both a person that is the subject of the estate and an entity associated with the estate, for access functionalities provided by the automated estate management system 208 in the management of an estate. In the example of operation of the example system shown in FIG. 2, the estate account management subsystem 212 functions to manage estate account data included as part of estate data for the estate. Additionally, in the example of operation of the example system shown in FIG. 2, the estate document management subsystem 214 functions to manage estate documents included as part of the estate data for the estate. In the example of operation of the example system shown in FIG. 2, the estate data access management subsystem 216 functions to manage access to the estate data for the estate.

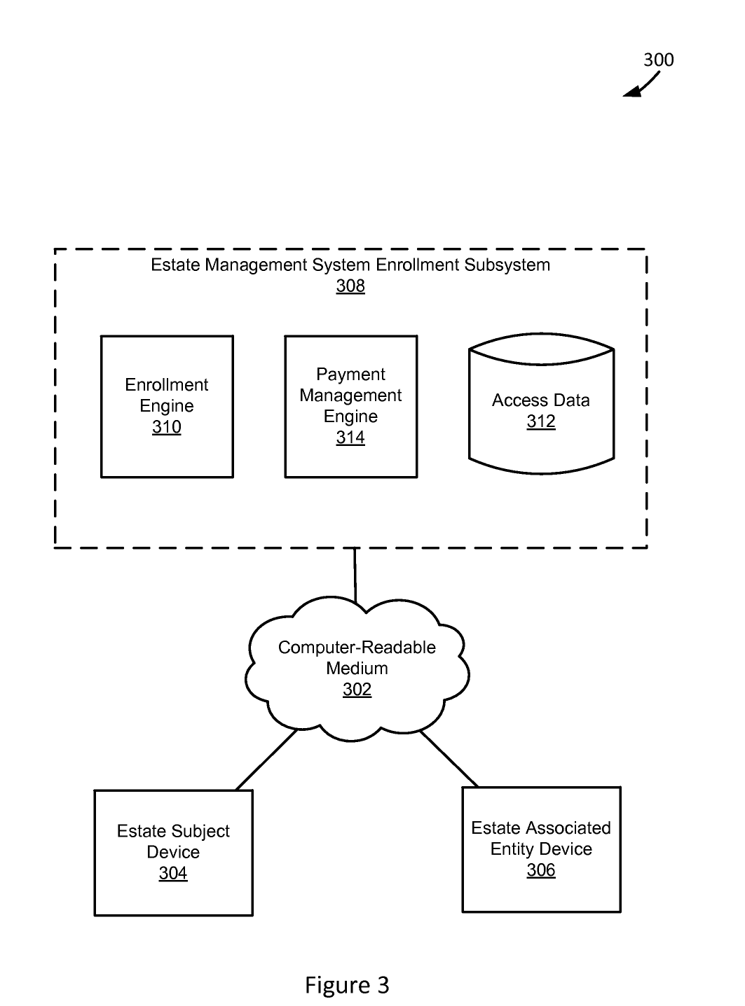

FIG. 3 depicts a diagram 300 of an example of a system for enrolling an entity in an automated estate management system. The example system shown in FIG. 3 includes a computer-readable medium 302, an estate subject device 304, an estate associated entity device 306, and an estate management system enrollment subsystem 308. In the example system shown in FIG. 3, the estate subject device 304, the estate associated entity device 306, and the estate management system enrollment subsystem 308 are coupled to each other through the computer-readable medium 302.

In a specific implementation, the estate subject device 304 functions according to an applicable device of a subject of an estate, such as the estate subject devices described in this paper. Depending upon implementation-specific or other considerations, the estate subject device 304 can include a wireless interface, through which the estate subject device 304 can be coupled to the computer-readable medium 302 and subsequently other devices, systems or engines coupled to the computer-readable medium 302, through a wireless connection. Further depending upon implementation-specific or other considerations, the estate subject device 304 can be a thin client device, or an ultra-thin client device. The estate subject device 304 can send and receive data, including payment data, used in enrolling entities with an automated estate management system.

In a specific implementation, the estate associated entity device 306 functions according to an applicable device of an entity associated with an estate, such as the estate associated entity devices described in this paper. Depending upon implementation-specific or other considerations, the estate associated entity device 306 can include a wireless interface, through which the estate associated entity device 306 can be coupled to the computer-readable medium 302, and subsequently other devices, systems or engines coupled to the computer-readable medium 302, through a wireless connection. Further depending upon implementation-specific or other considerations, the estate associated entity device 306 can be a thin client device, or an ultra-thin client device. The estate associated entity device 306 can send and receive data, including payment data, used in enrolling entities with an automated estate management system.

In a specific implementation, the estate management system enrollment subsystem 308 functions according to an applicable system for enrolling entities, such as the estate management system enrollment subsystems described in this paper. Depending upon implementation-specific or other considerations, the estate management system enrollment subsystem 308 can enroll a person that is the subject of an estate or an entity associated with an estate. In enrolling an entity, the estate management system enrollment subsystem 308 can function to receive payment data and verify whether an entity, including a person that is the subject of an estate, has paid. Additionally, in enrolling an entity, the estate management system enrollment subsystem 308 can function to receive and/or generate access data. For example, the estate management system enrollment subsystem 308 can create a login identification and password through which an entity can access an estate management system or generate a token used by the entity to gain access to the estate management system.

In the example system shown in FIG. 3, the estate management system enrollment subsystem 308 includes an enrollment engine 310, an access data datastore 312, and a payment management engine 314. In a specific implementation, the enrollment engine 310 functions to enroll an entity for using an estate management system. In enrolling an entity for using an estate management system, the enrollment engine 310 can receive data, including identification information of an entity from an applicable device used by the entity, e.g. the estate subject device 304 or the estate associated entity device 306. Identification information of an entity can include the name of an entity, a financial account of an entity, access information used to access the financial account of the entity, and a region of which the entity is associated. Further, in enrolling an entity, the enrollment engine 310 can generate and/or assign login information, or a token, included as part of the access data 312, to the entity that can be used by the entity to access an estate management system. For example, the enrollment engine 310 can assign a username and/or password that can be used by an entity to access an estate management system.

In a specific implementation, the access data datastore 312 functions to store access data. Depending upon implementation-specific or other considerations, access data can be stored in the access data datastore 312 in an encrypted format. Access data stored in the access data datastore 312 can be used to determine an entity to grant access to estate data, what estate data to grant access to, and when to grant an entity access to the estate data. For example access data stored in the access data datastore 312 can specify identifications of entities allowed to access estate data, what specific estate data the entities can access, and what access conditions must be met before the entities can access the specific estate data.

In a specific implementation, the enrollment engine 310 can generate access data stored in the access data datastore 312. Depending upon implementation-specific or other considerations, the enrollment engine 310 can generate access data based on data received from either or both the estate subject device 304 and the estate associated entity device 306. For example, if a person that is the subject of an estate wants to grant access to estate data for the estate to an administrator of the estate once the person that is the subject of the estate dies, as expressed through data received from the estate subject device 304, then the enrollment engine 310 can generate estate data specifying to grant access to the estate data to the administrator of the estate with the access condition of the person that is the subject of the estate must be deceased. In another example, the enrollment engine 310 can generate access data that specifies to grant an executor access to estate data for an estate, if either or both a person that is the subject of the estate specifically authorizes access for the executor or the person that is the subject of the estate becomes incapacitated.

In a specific implementation, the payment engine 314 functions to prompt an entity for payment and receive payment from the entity to gain access to services provided by an estate management system. Depending upon implementation-specific or other considerations, the payment engine can prompt and receive payment data from a person that is the subject of an estate or an entity associated with the estate through either or both the estate subject device 304 and estate associated entity device 306. In managing payment, the payment engine 314 can function to receive payment data from an entity and verify the payment data to ensure that the entity has paid for the right to use services provided by an estate management system.

In a specific implementation, the payment engine 314 functions to generate access data stored in the access data datastore 312. In generating access data, the payment engine 314 can generate access data based on whether an entity has paid. For example, the payment engine 314 can generate an access condition included in access data for an entity specifying to grant the entity access to estate data if payment is received from the entity.

In an example of operation of the example system shown in FIG. 3, the estate subject device 304 and the estate associated entity device 306 send and receive data used to enroll entities in using services provided by an estate management system. In an example of operation of the example system shown in FIG. 3, the enrollment engine 310 functions to enroll a person that is the subject of an estate through data received from and sent to the estate subject device 304. Further, in the example of operation of the example system shown in FIG. 3, the enrollment engine 310 functions to generate access data, stored in the access data datastore 312, based on data sent to and received from the estate subject device 304. In the example of operation of the example system shown in FIG. 3, the payment management engine 314 functions to verify whether the person that is the subject of the estate has paid and generate access conditions included as part of the access data specifying to grant access to estate data to the person that is the subject of the estate only once they have paid.

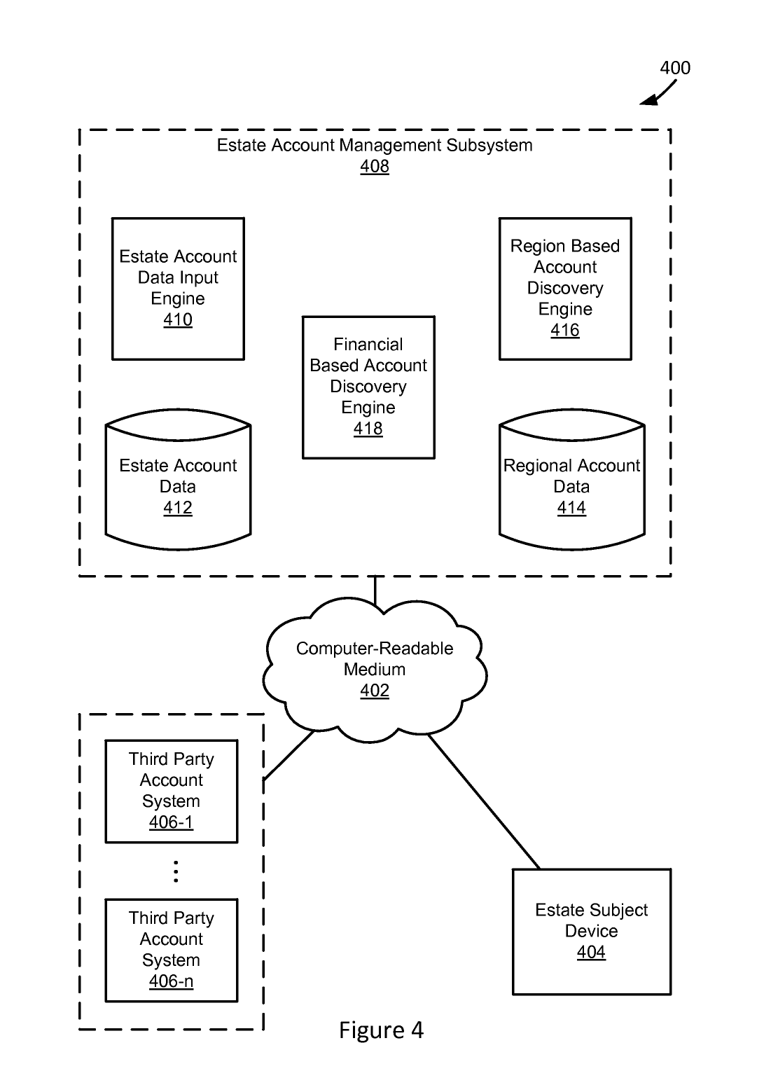

FIG. 4 depicts a diagram 400 of an example of a system for managing estate accounts associated with an estate. The example system shown in FIG. 4 includes a computer-readable medium 402, an estate subject device 404, third party account system 406-1 . . . 406-n (hereinafter referred to as “third party account systems 406”), and an estate account management subsystem 408. In the example system shown in FIG. 4, the estate subject device 404, the third party account systems 406, and the estate account management subsystem 408 are coupled to each other through the computer-readable medium 402.

In a specific implementation, the estate subject device 404 functions according to an applicable device of a subject of an estate, such as the estate subject devices described in this paper. Depending upon implementation-specific or other considerations, the estate subject device 404 can include a wireless interface, through which the estate subject device 404 can be coupled to the computer-readable medium 402 and subsequently other devices, systems or engines coupled to the computer-readable medium 402, through a wireless connection. Further depending upon implementation-specific or other considerations, the estate subject device 404 can be a thin client device, or an ultra-thin client device. The estate subject device 404 can send and receive data used in managing estate accounts of an estate.

In a specific implementation, the third party account systems 406 are systems of third party accounts. The third party account systems 406 can form a set of third party account systems. Assuming that a set of third party account systems formed by the third party account systems 406 is a proper set, it includes at least one third party account system. Depending upon implementation-specific or other considerations, a third party account system of the third party account systems 406 can be part of a system of a provider of an estate account of an estate. For example, a third party account system of the third party account systems 406 can be a system of a provider of a financial account of a person that is the subject of an estate. Further depending upon implementation-specific or other considerations, a third party account system of the third party account systems 406 is an entity associated with an estate. For example, a third party account system of the third party account systems 406 can include a system of an executor of an estate, e.g. an e-mail system used by the executor of the estate. Applicable systems and devices can retrieve estate account data from the third party account systems 406 for estate accounts of an estate.

In a specific implementation, the estate account management subsystem 408 functions according to an applicable system for managing estate accounts of an estate, such as the estate account management subsystems described in this paper. In managing estate accounts, the estate account management subsystem 408 can receive estate account data, included as part of estate data. Depending upon implementation-specific or other considerations, the estate account management subsystem 408 can receive estate account data from either or both the estate subject device 404 and the third party account systems 406. Additionally, in managing estate accounts, the estate account management subsystem 408 can discover accounts a person associated with an estate might hold. Depending upon implementation-specific or other considerations, the estate account management subsystem 408 can discover accounts a person associated with an estate might hold based on a region associated with the person associated with the estate. For example, the estate account management subsystem 408 can use a region associated with a person that is the subject of an estate, included as identification information received from the estate subject device 404, to discover estate accounts of the estate. Further depending upon implementation-specific or other considerations, the estate account management subsystem 408 can discover accounts a person associated with an estate might hold using a financial account of the person associated with the estate.

In the example system shown in FIG. 4, the estate account management subsystem 408 includes an estate account data input engine 408, an estate account data datastore 412, a regional account data datastore 414, a region based account discovery engine 416, and a financial based account discovery engine 418. In a specific implementation, the estate account data input engine 410 functions to receive estate account data of estate accounts of an estate. The estate account data input engine 410 can receive estate account data from an applicable source, including the estate subject device 404 and/or the third party account systems 406. Estate account data, included as part of estate data, can include identification information of an entity, including the name of an entity, a financial account of an entity, access information used to access the financial account of the entity, and a region of which the entity is associated. Depending upon implementation-specific or other considerations, the estate account data input engine 410 can receive estate account data without prompting an entity associated with an estate. For example, the estate account data input engine 410 can receive estate account data about accounts associated with an estate from a person that is the subject of the estate when the person is enrolled in the system. Further depending upon implementation-specific or other considerations, the estate account data input engine 410 can receive estate account data for a discovered estate account.

In a specific implementation, the estate account data datastore 412 functions to store estate account data of an estate. Depending upon implementation-specific or other considerations, estate account data can be stored in the estate account data datastore 412 in an encrypted format. Estate account data stored in the estate account datastore 412 can be received by the estate account data input engine 410. Estate account data can include an identification of an estate account associated with an estate. For example, estate account data can include an identification of a utility provider account held by a person that is the subject of an estate. Depending upon implementation-specific or other considerations, estate account data can include an account number of an estate account associated with an estate and/or access information used to access the estate account. For example, estate account data can include user login information for accessing an account associated with an estate.

In a specific implementation, the regional account data datastore 414 functions to store regional account data. Regional account data can include accounts commonly had by people in a specific region. For example, if a substantial number of people within a specific region have accounts with a specific utility provider then the regional account data can indicate that accounts with the specific utility provider are common in the region. Depending upon implementation-specific or other considerations, accounts commonly had by people in a specific region can be determined based on accounts associated with estates determined based on financial accounts of people that are the subjects of the estates. For example, if accounts for a specific gym are discovered based upon financial accounts of people within a region that are the subject of estates, then the regional account data can indicate that accounts with the specific gym are common in the region. Further depending upon implementation-specific or other considerations, accounts commonly had by people in a specific region can be determined based on input from users. For example, if a substantial number of users within a region input estate account data, included as part of estate data, indicate that they have an account with a specific gym, then the regional account data can indicate that accounts with the specific gym are common in the region.

In a specific implementation, the region based account discovery engine 416 functions to determine an account associated with an estate based on a region associated with a person associated with the estate. A region associated with a person can include a region in which the person lives in or once lived. In determining accounts associated with an estate, depending upon implementation-specific or other considerations, the region based account discovery engine 416 can determine a region associated with a person that is the subject of the estate based on estate data for the estate. For example, the region based account discovery engine 416 can determine a region based on a bank statement of a person that is the subject of an estate, included as part of estate data for the estate.

In a specific implementation, in determining accounts associated with an estate based on a region associated with a person associated with the estate, the region based account discovery engine 416 can use regional account data stored in the regional account data datastore 414. The regional based account discovery engine 416 can use a determined region associated with a person along with regional account data to determine accounts associated with an estate. For example, the regional based account discovery engine 416 can determine accounts common to people in a region associated with a person associated with an estate are accounts associated with the estate.

In a specific implementation, the region based account discovery engine 416 can verify whether a discovered account does in fact exist for a person associated with an estate, and is therefore an estate account associated with the estate. In verifying a discovered account, the region based account discovery engine 416 can query an account provider of the account to verify whether the account does in fact exist for a person that is associated with an estate. Depending upon implementation-specific or other considerations, the region based account discovery engine 416 can instruct the estate account data input engine 410 not to gather or otherwise receive estate account data for the discovered account, if the region based account discovery engine 416 verifies that the discovered account does not exist.

In a specific implementation, the financial based account discovery engine 418 functions to discover accounts associated with an estate based on financial data. Depending upon implementation-specific or other considerations, in discovering accounts associated with an estate based on financial data, the financial based account discovery engine 418 can access a financial account of a person that is the subject of the estate. The financial based account discovery engine 418 can access a financial account through a financial system of the provider of the financial account using estate account data of the financial account. In discovering estate account based on a financial account of a person that is the subject of an estate, the financial based account discovery engine 418 can look at transactions in the financial account of the person. For example, if a financial account indicates that a person makes monthly transaction to a utility provider, then the financial based account discovery engine 418 can determine an account with the utility provider is an estate account of an estate of which the person is the subject.

In a specific implementation, the financial based account discovery engine 418 can verify whether a discovered account does in fact exist for a person that is the subject of an estate, and is therefore an account associated with the estate. In verifying a discovered account, the financial based account discovery engine 418 can query an account provider of the account to verify whether the account does in fact exist. Depending upon implementation-specific or other considerations, the financial based account discovery engine 418 can instruct the estate account data input engine 410 not to gather or other received estate account data for a discovered account, if the financial based account discovery engine 418 verifies that the discovered account does not exist.

In an example of operation of the example system shown in FIG. 4, the estate account data input engine 410 functions to receive estate account data for estate accounts of an estate from either or both the estate subject device 404 and the third party account systems 406. In the example of operation of the example system shown in FIG. 4, the estate account data datastore 412 stores the estate account data received by the estate account data input engine 410. Further, in the example of operation of the example system shown in FIG. 4, the regional based account discovery engine 416 functions to discover estate accounts of the estate using regional account data stored in the regional account datastore 414, and a region associated with an entity associated with the estate. In the example of operation of the example system shown in FIG. 4, the financial based account discovery engine 418 functions to discover estate accounts of the estate based on a financial account of a person that is the subject of the estate using estate account data for the financial account.

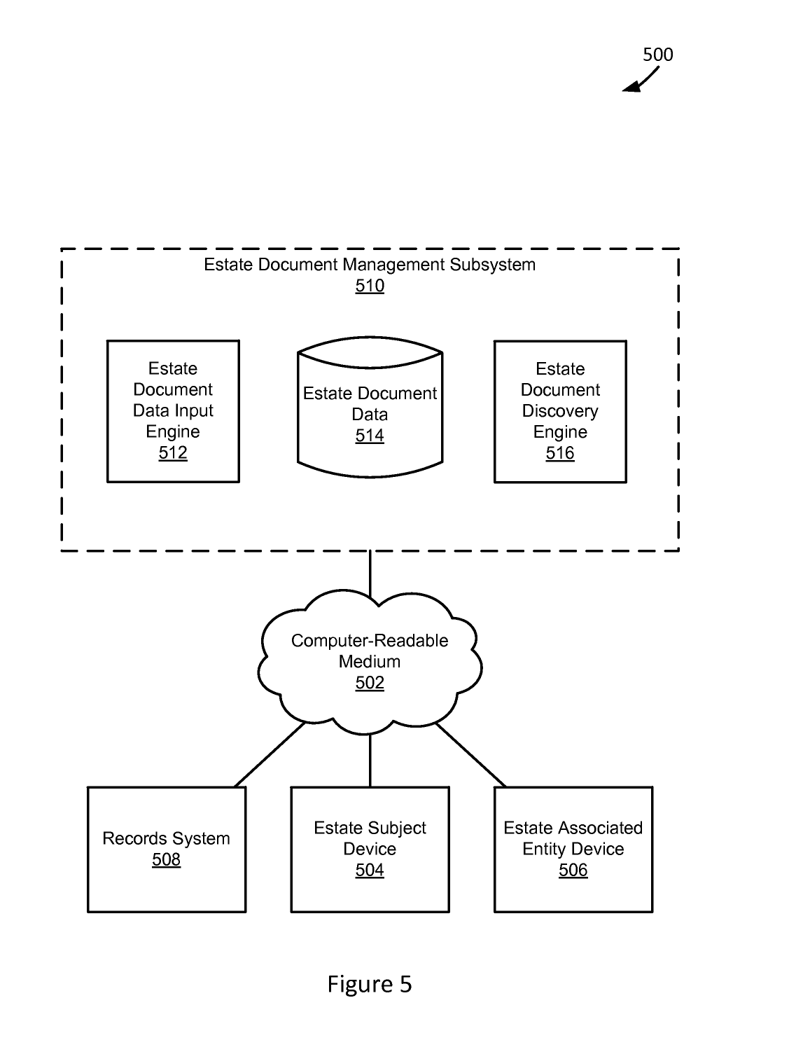

FIG. 5 depicts a diagram 500 of an example of a system for managing estate documents of an estate. The example system shown in FIG. 5 includes a computer-readable medium 502, an estate subject device 504, an estate associated entity device 506, a records system 508, and an estate document management subsystem 510. In the example system shown in FIG. 5, the estate subject device 504, the estate associated entity device 506, the records system 508, and the estate document management subsystem 510 are coupled to each other through the computer-readable medium 502.

In a specific implementation, the estate subject device 504 functions according to an applicable device of a subject of an estate, such as the estate subject devices described in this paper. Depending upon implementation-specific or other considerations, the estate subject device 504 can include a wireless interface, through which the estate subject device 504 can be coupled to the computer-readable medium 502 and subsequently other devices, systems or engines coupled to the computer-readable medium 502, through a wireless connection. Further depending upon implementation-specific or other considerations, the estate subject device 504 can be a thin client device, or an ultra-thin client device. The estate subject device 504 can send and receive data, including estate documents, used in managing estate documents of an estate.

In a specific implementation, the estate associated entity device 506 functions according to an applicable device of an entity associated with an estate, such as the estate associated entity devices described in this paper. Depending upon implementation-specific or other considerations, the estate associated entity device 506 can include a wireless interface, though which the estate associated entity device 506 can be coupled to the computer-readable medium 502, and subsequently other devices, systems or engines coupled to the computer-readable medium 502, through a wireless connection. Further depending upon implementation-specific or other considerations, the estate associated entity device 506 can be a thin client device, or an ultra-thin client device. The estate associated entity device 506 can send and receive data, including estate documents, used in managing estate documents of an estate.

In a specific implementation, the records system 508 functions according to an applicable system for storing records and facilitating access to records. The records system 508 can be part of facilitate access to public records. For example, the records system 508 can be part of or facilitate access to county records, state records, and/or court records. Depending upon implementation-specific or other considerations, the records system 508 includes or facilitates access to deaths within a region, and/or an identification of people who are legally responsible for management of estates of dead people.

In a specific implementation, the estate documents management subsystem 510 functions according to an applicable system for managing estate documents of an estate, such as the estate document management subsystems described in this paper. In managing estate documents, the estate document management subsystem 510 can receive estate documents associated with an estate, included as part of estate data for the estate. Depending upon implementation-specific or other considerations, in managing estate documents associated with an estate, the estate document management subsystem 510 can receive estate documents from either or both a person that is the subject of an estate or an entity associated with the estate. For example, the estate document management subsystem 510 can receive a death certificate of a person that is the subject of an estate from an entity associated with the estate through the estate associated entity device 506. In managing estate documents associated with an estate, the estate document management subsystem 510 can function to discovery estate documents associated with an estate. For example, the estate document management subsystem 510 can discover a will for an estate using the records system 508.

In the example system shown in FIG. 5, the estate document management subsystem 510 includes an estate document data input engine 512, an estate document data datastore 514, and an estate document discovery engine 516. In a specific implementation, the estate document data input engine 512 functions to receive estate documents data for estate documents of an estate. Estate document data can include an estate document and applicable information characterizing or otherwise describing the estate document. For example, estate document data for an estate document can include a will and data describing the estate document as being a will. Depending upon implementation-specific or other considerations, the estate document data input engine 512 can receive an estate document, characterize the estate document, and generate estate document data for the estate document based on the characterization of the estate document. For example, the estate document data input engine 512 can receive a will, characterize the estate document as being a will, and generate estate document data describing that the estate document is a will.

In a specific implementation, the estate document data input engine 512 can receive estate document data from at least one of the estate subject device 504, the estate associated entity device 506, and the records system 508. Depending upon implementation-specific or other considerations, the estate document data input engine 512 can receive estate document after prompting an applicable system or device for the estate document data. Further depending upon implementation-specific or other considerations, the estate document data input engine 512 can receive estate document data of a discovered estate document.

In a specific implementation, the estate document data datastore 514 functions to store estate document data. Depending upon implementation-specific or other considerations, estate document data can be stored in the estate document data datastore 514 in an encrypted format. Estate document data stored in the estate document data datastore 514 can include estate documents and characteristics or descriptions of estate documents. The estate document data datastore 514 can store estate documents received by the estate document data input engine 512.

In a specific implementation, the estate document discovery engine 516 functions to discover estate documents associated with an estate. Depending upon implementation-specific or other considerations, the estate document discovery engine 516 can discover estate documents after being instructed to find estate documents. Further depending upon implementation-specific or other considerations, the estate document discovery engine 516 can discover estate documents residing on or accessed through one of at least the estate subject device 504, the estate associated entity device 506, and the records system 508. Upon discovering an estate document, the estate document discovery engine 516 can instruct the estate document data input engine 512 to collect or receive estate document data for the discovered estate document.

In an example of operation of the example system shown in FIG. 5, the estate document data input engine 512 functions to receive estate document data of an estate document for an estate from at least one of the estate subject device 504, the estate associated entity device, and the records system 508. In the example of operation of the example system shown in FIG. 5, the estate document data datastore 514 functions to store the estate document data received by the estate document data input engine 512. Further, in the example of operation, the estate document discovery engine 516 functions to discover estate documents associated with the estate, and instruct the estate document data input engine 512 to collect or receive estate document data for the discovered estate document.

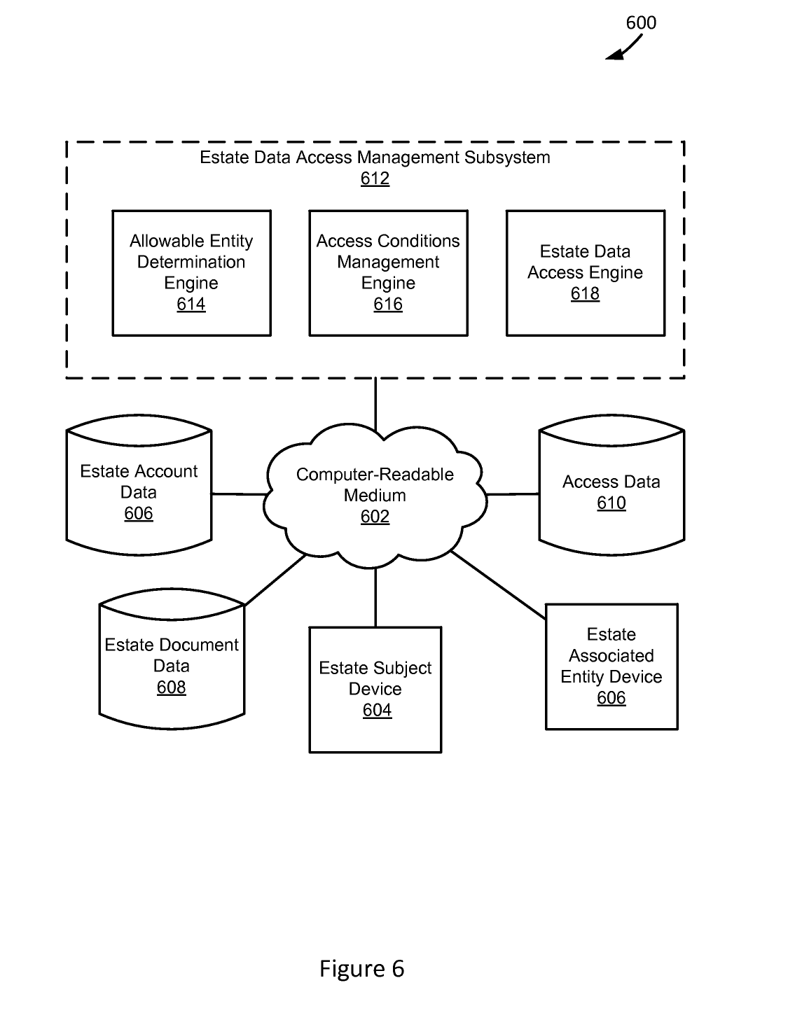

FIG. 6 depicts a diagram 600 of an example of a system for managing access to estate data through an estate management system. The example system shown in FIG. 6 includes a computer-readable medium 602, an estate subject device 604, an estate associated entity device 606, an estate account data datastore 606, an estate document data datastore 608, an access data datastore 610, and an estate data access management subsystem 612. In the example system shown in FIG. 6, the estate subject device 604, the estate associated entity device 606, the estate account data datastore 606, the estate document data datastore 608, the access data datastore 610, and the estate data access management subsystem 612 are coupled to each other through the computer-readable medium 602.

In a specific implementation, the estate subject device 604 functions according to an applicable device of a subject of an estate, such as the estate subject devices described in this paper. Depending upon implementation-specific or other considerations, the estate subject device 604 can include a wireless interface, through which the estate subject device 604 can be coupled to the computer-readable medium 602 and subsequently other devices, systems or engines coupled to the computer-readable medium 602, through a wireless connection. Further depending upon implementation-specific or other considerations, the estate subject device 604 can be a thin client device, or an ultra-thin client device. The estate subject device 604 can send and receive data used in accessing estate data and managing access to the estate data.

In a specific implementation, the estate associated entity device 606 functions according to an applicable device of an entity associated with an estate, such as the estate associated entity devices described in this paper. Depending upon implementation-specific or other considerations, the estate associated entity device 606 can include a wireless interface, though which the estate associated entity device 606 can be coupled to the computer-readable medium 602, and subsequently other devices, systems or engines coupled to the computer-readable medium 602, through a wireless connection. Further depending upon implementation-specific or other considerations, the estate associated entity device 606 can be a thin client device, or an ultra-thin client device. The estate associated entity device 606 can send and receive data used in accessing estate data and managing access to the estate data.

In a specific implementation, the estate account data datastore 606 functions according to an applicable datastore for storing estate account data, such as the estate account data datastores described in this paper. Estate account data stored in the estate account data datastore 606 can include an identification of an estate account associated with an estate. For example, estate account data can include an identification of a utility provider account held by a person that is the subject of an estate. Depending upon implementation-specific or other considerations, estate account data stored in the estate account datastore 606 can include an account number of an estate account associated with an estate and/or access information used to access the estate account. For example, estate account data can include user login information for accessing an account associated with an estate.

In a specific implementation, the estate document data datastore 608 functions according to an applicable datastore for storing estate document data, such as the estate document data datastores described in this paper. Estate document data stored in the estate document data datastore 608 can include estate documents of an estate. Estate document data stored in the estate document data datastore 608 can also include characteristics or descriptions of estate documents.

In a specific implementation, the access data datastore 610 functions according to an applicable datastore for storing access data, such as the access datastores described in this paper. Access data can include what entities are allowed to access estate data and what portions of estate data the entities are allowed to access. For example, access data can specify that a beneficiary of an estate can only access a will included as part of estate data for the estate, while an executor of the estate can access estate account data of accounts associated with the estate. Access data can also include access conditions that need to be met before an entity can access estate data that they are authorized to access. For example access data can include an access condition specifying that an executor of an estate can access estate account data of accounts associated with an estate after a person that is the subject the estate has died.

In a specific implementation, the estate data access management subsystem 612 functions according to an applicable system for managing access to estate data, such as the estate data access management systems described in this paper. Depending upon implementation-specific or other considerations, in managing access to estate data, the estate data access management subsystem 612 can either or both, allow an entity to access the estate data through an applicable estate management system, or send the estate data to an entity. In managing access to estate data, the estate data access management subsystem 612 can determine which entities are allowed to access specific estate data, and what access conditions must be met before an entity can be allowed to access estate data. Further, in managing access to estate data, the estate data access management subsystem 612 can determine whether access conditions have been met in order to grant access to estate data.

In the example system shown in FIG. 6, the estate data access management subsystem 612 includes an allowable entity determination engine 614, an access conditions management engine 616, and an estate data access engine 618. In a specific implementation, the allowable entity determination engine 614 functions to determine what entities are allowed to access estate data and what parts of the estate data the entities are allowed to access. In determining what entities are allowed to access estate data, the allowable entity determination engine 614 can determine entities allowed to access estate data using access data stored in the access data datastore 610. For example, if access data stored in the access data datastore 610 specifies that an executor of an estate is allowed to access estate data, then the allowable entity determination engine 614 can determine that the executor of the estate is allowed to access the estate data.

In a specific implementation, the allowable entity determination engine 614 can determine what portion of estate data an entity is allowed to access. The allowable entity determination engine 614 can determine what portion of estate data an entity is allowed to access using access data stored in the access data datastore 610. For example, if access data stored in the access data datastore 610 specifies to allow an executor of an estate to access a first subset of estate data, then the allowable entity determination engine 614 can determine that the executor can access the first subset of the estate data.

In a specific implementation, the access conditions management engine 616 functions to determine access conditions for accessing estate data. Depending upon implementation-specific or other considerations, access conditions determined by the access conditions management engine 616 can be specific to an entity and/or specific to a subset of estate data that the entity can access. For example, the access conditions management engine 616 can determine an access condition specifying that an executor of an estate is not allowed to access estate data for the estate until a person that is the subject of the estate has died. In another example, the access conditions management engine 616 can determine an access condition specifying that an executor of an estate is not allowed to access estate accounts data for the estate until a person that is the subject of the estate either grants access to the executor or has become incapacitated. The access conditions management engine 616 can determine access conditions from access data stored in the access data datastore 610.

In a specific implementation, the access conditions management engine 616 functions to determine whether access conditions are met. For example, if access conditions specify a user must provide correct login information in order to access estate data for an estate, the access conditions management engine 616 can receive login information from the user and verify that the login information is correct, e.g. by using access data stored in the access data datastore 610. In another example, if access conditions specify a user must provide proof that a person that is the subject of an estate has died before allowing the user to access estate data for the estate, then the access conditions management engine 616 can receive a death certificate of the person from the user and check to verify that the death certificate is valid, to determine whether the access condition is met.

In a specific implementation, the estate data access engine 618 functions to provide access to estate data to an entity. Depending upon implementation-specific or other considerations, in providing access to estate data, the estate data access engine 618 can either or both send estate data to a device used by an entity or allow an entity to view the estate data through a device used by an entity. For example, the estate data access engine 618 can allow an entity associated with an estate to view estate data through the estate associated entity device 608. The estate data access engine 618 can be configured to allow an entity to access estate data if the entity is determined to be an allowable entity by the allowable entity determination engine 614 and/or if access conditions for the entity are determined to be met by the access conditions management engine 616.

In an example of operation of the example system shown in FIG. 6, the allowable entity determination engine 614 functions to determine whether an entity is an entity allowed to access estate data. In the example of operation of the example system shown in FIG. 6, the access conditions management engine 616 functions to determine access conditions for the entity to access the estate data and whether the access conditions are met. Further, in the example of operation of the example system shown in FIG. 6, the estate data access engine 618 functions to provide access for the entity to the estate data if it is determined that the entity is an allowable entity and that the access conditions for the entity are met.

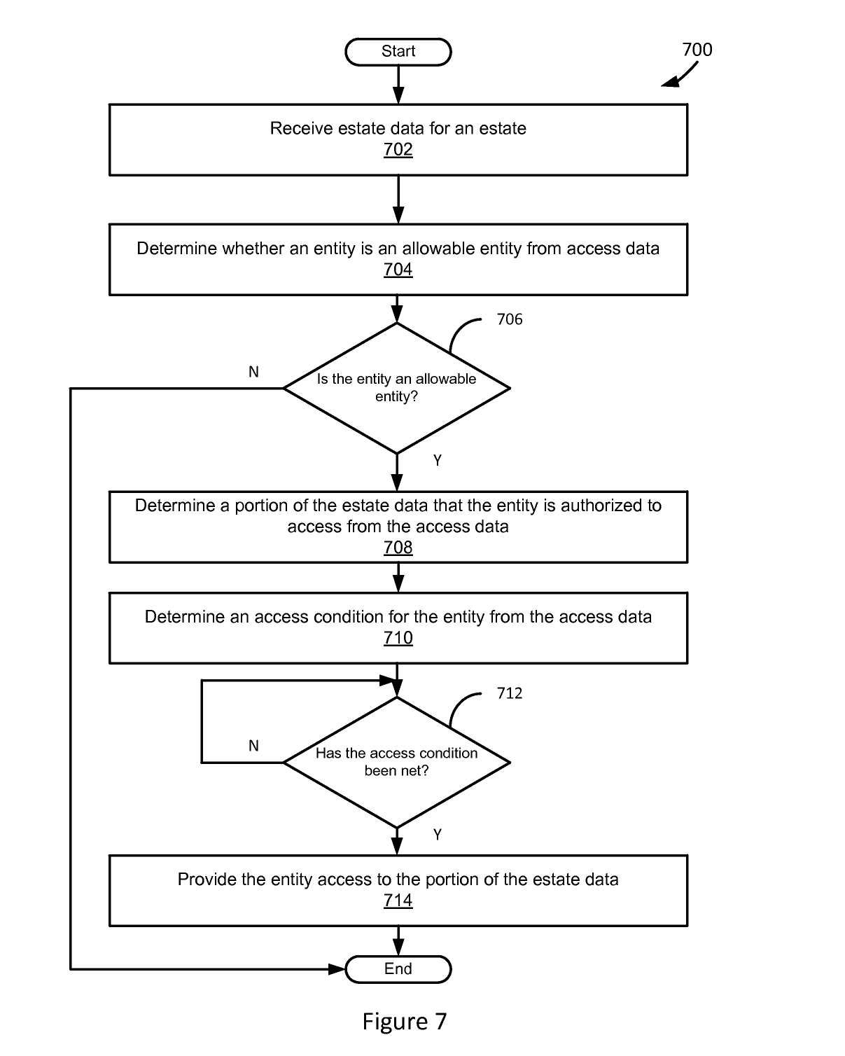

FIG. 7 depicts a flowchart 700 of an example of a method for managing access to estate data. The flowchart begins at module 702, where estate data for an estate is received. Estate data received at module 702 can include estate account data for accounts associated with an estate and estate document data of estate documents of the estate. Depending upon implementation-specific or other considerations estate data can be received from a person that is the subject of an estate or an entity associated with the estate, e.g. an executor of the estate. Further depending upon implementation-specific or other considerations, estate data can be received for either or both a discovered estate account and a discovered estate document.

The flowchart 700 continues to module 704, where it is determined whether an entity is an allowable entity to access the estate data using access data. As used in this paper, an allowable entity is an entity that has been granted the right to access at least a portion of estate data. Access data can specify what entities are allowed to access the estate data. Depending upon implementation-specific or other considerations, access data can be received from or generated in response to input received from a person that is the subject of the estate.

The flowchart 700 continues to decision point 706, where it is determined whether the entity is an allowable entity. If it is determined that the entity is not an allowable entity, then the flowchart 700 ends. If it is determined that the entity is an allowable entity, then the flowchart 700 continues to module 708.

At module 708, the flowchart 700 includes determining a portion of the estate data that the entity is authorized to access using the access data. Access data can specify a portion of the estate data an entity is allowed to access. For example, it can be determined at module 708 that an executor of the estate is allowed to access estate account data included as part of the estate data. Depending upon implementation-specific or other considerations, an entity might be a person that is the subject of an estate and not be an allowable entity or might only be able to access portions of the estate data.

The flowchart 700 continues to module 710, where an access condition for the entity is determined from the access data. Depending upon implementation-specific or other considerations, a plurality of access conditions for the entity can be determined at module 710 from the access data. Access conditions for the entity can specify access conditions, specific to an entity, that must be met before the entity can access a portion of the estate data the entity is authorized to access. For example, access conditions can be determined at module 710 specifying that payment must be received before the entity can be allowed to access the portion of the estate data. In another example, access condition can be determined at module 710 specifying that the entity must provide proof that a person that is the subject of the estate has died before the entity is allowed to access the portion of the estate data.

The flowchart 700 continues to decision point 712 where it is determined whether the access condition, determined at module 710, has been met. For example if the access condition specifies that the entity must provide valid login information, it can be determined at module 712 whether the entity has provided valid login information. If it is determined at decision point 712 that the access condition has been met, then the flowchart 700 continues to module 714.

At module 714, the flowchart 700 includes providing the entity access to the portion of the estate data. Depending upon implementation-specific or other considerations, in providing the entity access to the portion of the estate data, the entity can be allowed to view the portion of the estate data through an applicable device for viewing estate data. Further depending upon implementation-specific or other considerations, in providing the entity access to the portion of the estate data, the portion of the estate data can be sent to a device used by the entity.

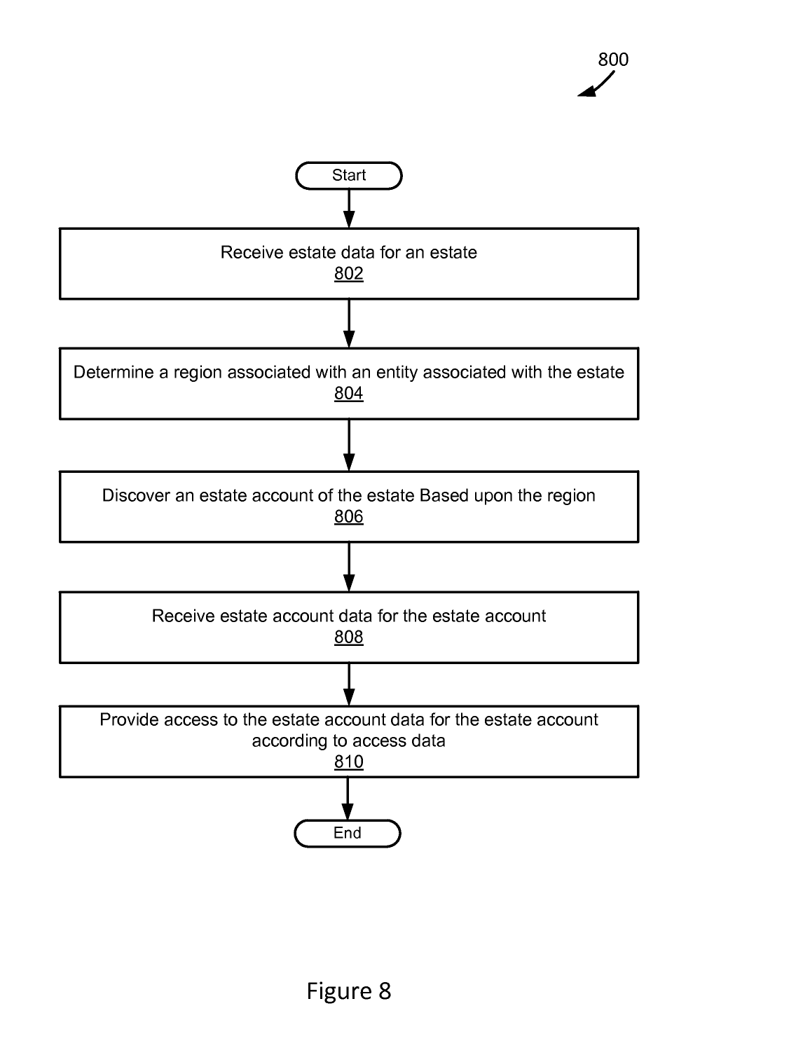

FIG. 8 depicts a flowchart 800 of an example of a method for providing access to estate account data of a discovered estate account of an estate. The flowchart 800 begins at module 802, where estate data for an estate is received. Estate data received at module 802 can include estate account data for accounts associated with an estate and estate document data of estate documents of the estate. Depending upon implementation-specific or other considerations estate data can be received from a person that is the subject of an estate or an entity associated with the estate, e.g. an executor of the estate. Further depending upon implementation-specific or other considerations, estate data can be received for either or both a discovered estate account and a discovered estate document.

The flowchart 800 continues to module 804, where a region associated with an entity associated with the estate is determined. Depending upon implementation-specific or other considerations, at module 804, a region associated with a person that is the subject of the estate is determined. A region associated with an entity can include a region in which an entity lives or once lived. A region associated with an entity can be determined at module 804 using the estate data received at module 802. For example, the estate data can specify a region associated with a person that is the subject of the estate. In another example, the estate data can specify a region associated with an estate account, e.g. a location of a gym or a utility provider.

The flowchart 800 continues to module 806, where an estate account of the estate is discovered based upon the region. Depending upon implementation-specific or other considerations, an estate account of the estate can be discovered based upon the region using regional account data. For example, if regional account data specifies people in the region have accounts with a specific provider, then it can be determined that a person that is the subject of the estate has an account with the specific provider.

The flowchart 800 continues to module 808, where estate account data for the estate account discovered at module 806 is received. Depending upon implementation-specific or other considerations, estate account data for the estate account can be received from either or both a person that is the subject of the estate and an entity associated with the estate. Further depending upon implementation-specific or other considerations, estate account data for the estate account can be received from a specific provider of the estate account.

The flowchart 800 continues to module 810 where access to the estate account data for the estate account is provided in accordance with access data. In providing access to the estate account data for the estate account in accordance with access data, access conditions can be determined using the access data. Additionally, in providing access to the estate account data for the estate account in accordance with access data, allowable entities for the estate account data can be determined. Depending upon implementation-specific or other considerations, in providing access to the estate account data, an entity can be allowed to view the estate account data through an applicable device for viewing estate data. Further depending upon implementation-specific or other considerations, in providing access to the estate account data, the estate account data can be sent to a device used by an entity.

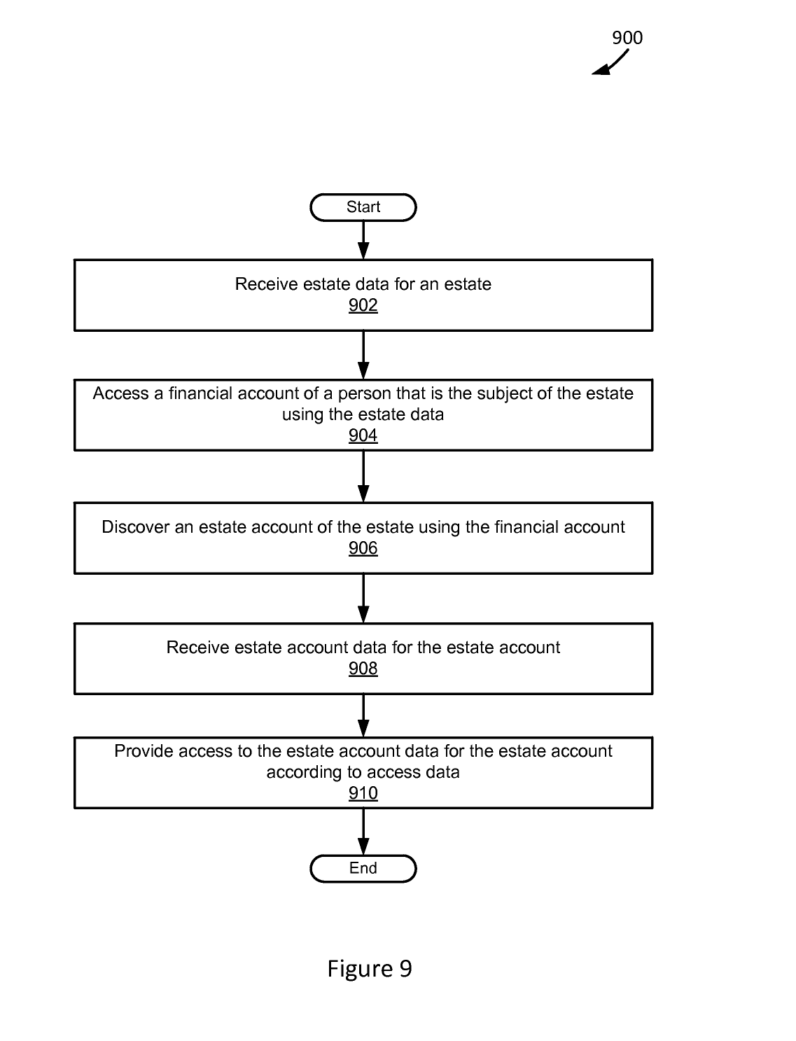

FIG. 9 depicts a flowchart 900 of an example of a method for providing access to estate account data of an estate account of an estate discovered using a financial account of a person that is the subject of the estate. The flowchart 900 begins at module 902, where estate data for an estate is received. Estate data received at module 902 can include estate account data for accounts associated with an estate and estate document data of estate documents of the estate. Estate account data received at module 902 can also include estate account data for a financial account of a person that is the subject of an estate. For example, estate account data receive at module 902 can include estate account data for a bank account or a credit account held by a person that is the subject of an estate. Depending upon implementation-specific or other considerations estate data can be received from a person that is the subject of an estate or an entity associated with the estate, e.g. an executor of the estate. Further depending upon implementation-specific or other considerations, estate data can be received for either or both a discovered estate account and a discovered estate document.

The flowchart 900 continues to module 904, where a financial account of a person that is the subject of the estate is accessed using the estate data. In accessing a financial account using the estate data, login information of a person that is the subject of an estate, as included as part of the estate data, can be used to access a financial account. Depending upon implementation-specific or other considerations, a financial account of a person that is the subject of the estate can be accessed through a system of a provider of the financial account.

The flowchart 900 continues to module 906, where an estate account of the estate is discovered using the financial account. In discovering an estate account of the estate using the financial account, payments made from the financial account can be used to determine the estate account. For example, if it is determined that a recurring payment is made to a provider, then it can be determined that an estate account of the estate exists with the provider.

The flowchart 900 continues to module 908, where estate account data for the estate account is received. Depending upon implementation-specific or other considerations, estate account data for the estate account can be received from either or both a person that is the subject of the estate and an entity associated with the estate. Further depending upon implementation-specific or other considerations, estate account data for the estate account can be received from a specific provider of the estate account.

The flowchart 900 continues to module 910 where access to the estate account data for the estate account is provided in accordance with access data. In providing access to the estate account data for the estate account in accordance with access data, access conditions can be determined using the access data. Additionally, in providing access to the estate account data for the estate account in accordance with access data, allowable entities for the estate account data can be determined. Depending upon implementation-specific or other considerations, in providing access to the estate account data, an entity can be allowed to view the estate account data through an applicable device for viewing estate data. Further depending upon implementation-specific or other considerations, in providing access to the estate account data, the estate account data can be sent to a device used by an entity.

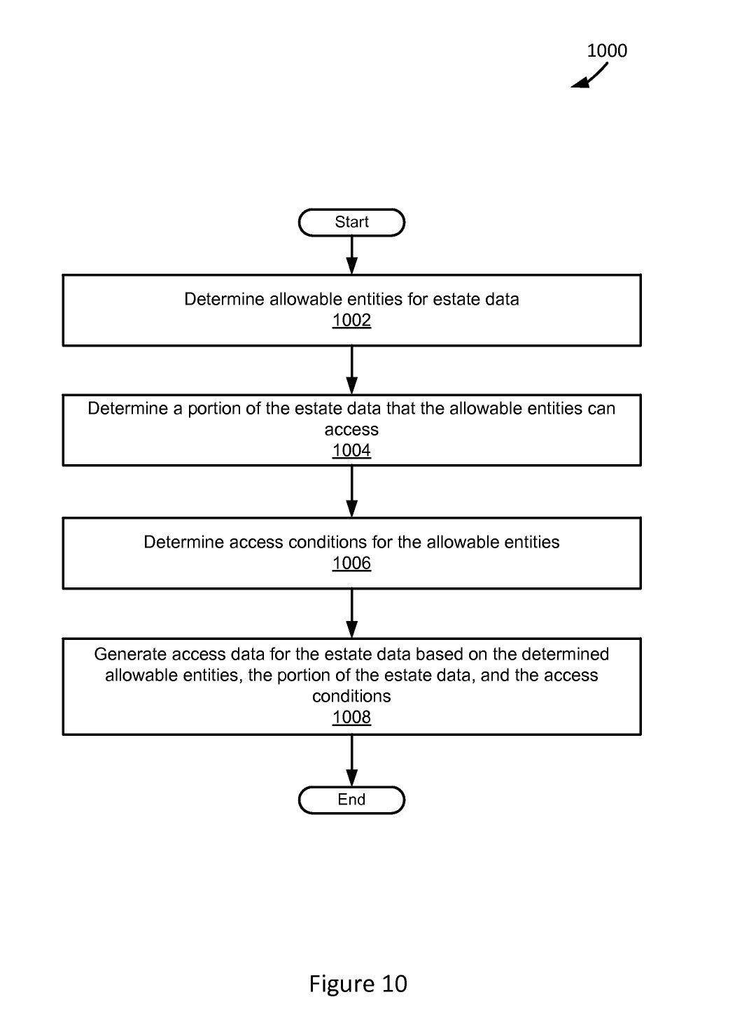

FIG. 10 depicts a flowchart 1000 of an example of a method for generating access data used in managing access to estate data. The flowchart 1000 begins at module 1002, where allowable entities for estate data are determined. Depending upon implementation-specific or other considerations, allowable entities for estate data can be determined from a person that is the subject of an estate. Further depending upon-implementation specific or other considerations, allowable entities for estate data can be determined from estate documents for an estate. For example, a will can specify an executor of an estate, and it can be determined from the will that the executor is an allowable entity for accessing estate data for the estate.

The flowchart 1000 continues to module 1004, where a portion of the estate data that the allowable entities can access is determined. Depending upon implementation-specific or other considerations, a portion of the estate data the allowable entities can access can be determined from a person that is the subject of an estate. Further depending upon-implementation specific or other considerations, a portion of the estate data the allowable entities can access is determined from estate documents for an estate. For example, a will can specify an executor of an estate, and it can be determined from the will that the executor is an allowable entity for accessing estate data for the estate.

The flowchart 1000 continues to module 1006, where access conditions for the allowable entities are determined. Depending upon implementation-specific or other considerations, access conditions for the allowable entities can be determined from a person that is the subject of an estate. Further depending upon-implementation specific or other considerations, access conditions for the allowable entities can be determined from estate documents for an estate. For example, a will can specify an executor of an estate, and it can be determined from the will that the executor is allowed to access the estate data for the estate if the person that is the subject of the estate properly pays for the right to access services provided for by an applicable estate management system.

The flowchart 1000 continues to module 1008 where access data is generated for the estate data based on the determined allowable entities, the determined portion of the estate data and the determined access conditions. At module 1008, access data can be generated specifying what entities are allowable entities, what portion of the estate data the allowable entities are allowed to access, and what access conditions must be met before the allowable entities can access the allowable portions of the estate data. For example, access data can be generated specifying an executor of an estate is allowed to access estate accounts data of the estate data upon proof that a person that is the subject of the estate has deceased.

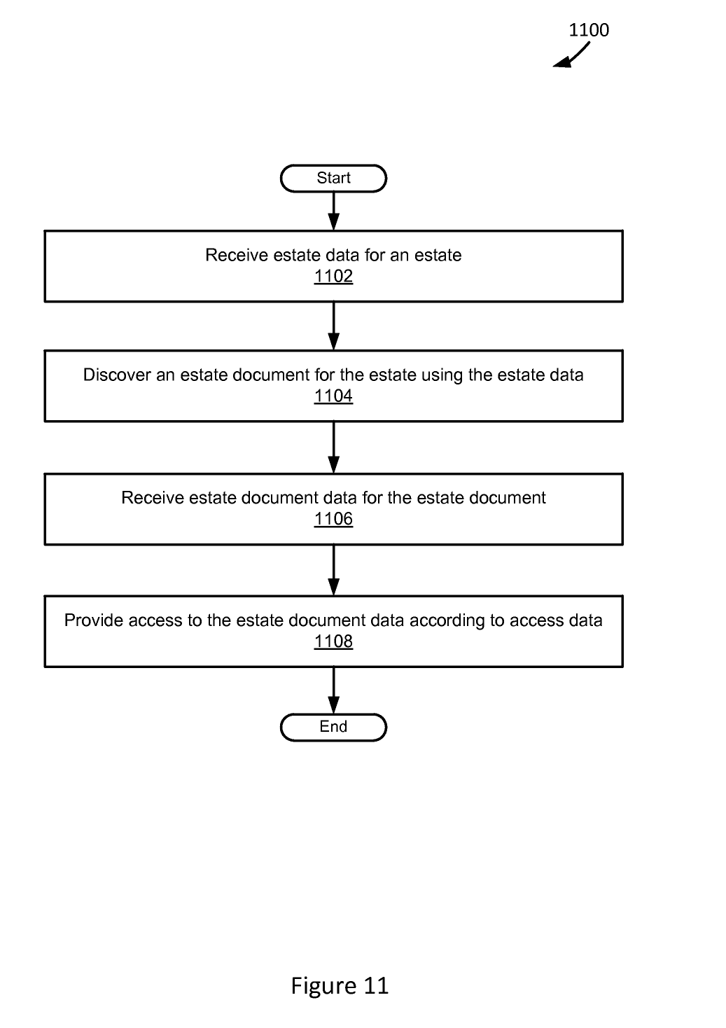

FIG. 11 depicts a flowchart 1100 of an example of a method for providing access to estate account data of a discovered estate document of an estate. The flowchart 1100 begins at module 1102 where estate data is received for an estate. Estate data received at module 1102 can include estate account data for accounts associated with an estate and estate document data of estate documents of the estate. Estate account data received at module 1102 can also include estate account data for a financial account of a person that is the subject of an estate. For example, estate account data receive at module 1102 can include estate account data for a bank account or a credit account held by a person that is the subject of an estate. Depending upon implementation-specific or other considerations estate data can be received from a person that is the subject of an estate or an entity associated with the estate, e.g. an executor of the estate.

The flowchart 1100 continues to module 1104, where an estate document for the estate is discovered using the estate data. Depending upon implementation-specific or other considerations, in discovering an estate document for the estate using the estate data, a name of a person that is the subject of the estate can be determined from the estate data. Further depending upon implementation-specific or other considerations, a name of a person that is the subject of the estate can be used to look up estate documents for the estate through a records system. For example, public records can be searched to find a death certificate of a person that is the subject of the estate.

The flowchart 1100 continues to module 1106, where estate document data for the estate document is received. Estate document data received at module 1106 can include the estate document and data describing the characteristics and/or document type of the estate document. For example, estate document data can include a will and a description that the estate document is a will. Depending upon implementation-specific or other considerations, estate document data can be received at module 1106 from an applicable records system, e.g. a public records system.

The flowchart 1100 continues to module 1108, where access to the estate document data is provided according to access data. In providing access to the estate document data for the estate in accordance with access data, access conditions can be determined using the access data. Additionally, in providing access to the estate document data for the estate in accordance with access data, allowable entities for the estate document data can be determined. Depending upon implementation-specific or other considerations, in providing access to the estate document data, an entity can be allowed to view the estate document data through an applicable device for viewing estate data. Further depending upon implementation-specific or other considerations, in providing access to the estate document data, the estate document data can be sent to a device used by an entity.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

We claim:

1. A method comprising:
receiving estate data for an estate;
determining whether an entity is an allowable entity from access data for the estate data;
determining at least a portion of the estate data that the entity is authorized to access from the access data;
determining at least one access condition for the entity to access the at least the portion of the estate data from the access data;
determining whether the at least one access condition is met;
if it is determined the entity is an allowable entity and the at least one access condition is met, providing the entity access to the at least the portion of the estate data.

2. The method of claim 1, wherein the access data is generated in response to input received from a person that is the subject of the estate.

3. The method of claim 1, wherein the estate data includes estate account data of estate accounts for the estate.

4. The method of claim 1, wherein the estate data includes estate document data of estate documents for the estate.

5. The method of claim 1, wherein the estate data includes estate account data of a financial account of a person that is the subject of the estate, the method further comprising:
accessing the financial account using the estate account data;
discovering an estate account of the estate through the financial account;
receiving estate account data for the estate account.

6. The method of claim 1, further comprising:
determining a region associated with a person that is the subject of the estate from the estate data;
discovering an estate account of the estate using the region and regional account data;
receiving estate account data for the estate account.

7. The method of claim 1, further comprising:
discovering an estate document of the estate from a records system using the estate data;
receiving estate document data for the estate document from the records system.

8. The method of claim 1, wherein the entity is an executor of the estate and the at least one access condition specifies that the executor of the estate must provide proof that a person that is the subject of the estate is deceased.

9. The method of claim 1, wherein the estate data is received from a person that is the subject of the estate.

10. The method of claim 1, wherein the estate data is received from an entity associated with the estate.

11. A system comprising:
an automated estate management system configured to receive estate data;
an allowable entity determination engine configured to:
determine whether an entity is an allowable entity from access data for the estate data;
determine at least a portion of the estate data that the entity is authorized to access from the access data;
an access conditions management engine configured to:
determine at least one access condition for the entity to access the at least the portion of the estate data from the access data;
determine whether the at least one access condition is met;
an estate data access engine configured to provide the entity access to the at least the portion of the estate data if it is determined the entity is an allowable entity and the at least one access condition is met.

12. The system of claim 1, further comprising an enrollment engine configured to generate the access data in response to input received from a person that is the subject of the estate.

13. The system of claim 1, further comprising an estate account data input engine configured to receive estate account data of estate accounts for the estate, the estate account data included as part of the estate data.

14. The system of claim 1, further comprising an estate document data input engine configured to receive estate document data of estate documents for the estate, the estate document included as part of the estate data.

15. The system of claim 1, where the estate data includes estate account data of a financial account of a person that is the subject of the estate, the system further comprising:
a financial based account discovery engine configured to:
access the financial account using the estate account data;
discover an estate account of the estate through the financial account;
an estate account data input engine configured to receive estate account data for the estate account.

16. The system of claim 1, further comprising:
a region based account discovery engine configured to:
determine a region associated with a person that is the subject of the estate from the estate data;
discover an estate account of the estate using the region and regional account data;
an estate account data input engine configured to receive estate account data for the estate account.

17. The system of claim 1,
an estate document discovery engine configured to discover an estate document of the estate from a records system using the estate data;
an estate document data input engine configured to receive estate document data for the estate document from the records system.

18. The system of claim 1, wherein the entity is an executor of the estate and the at least one access condition specifies that the executor of the estate must provide proof that a person that is the subject of the estate is deceased.

19. The system of claim 1, wherein the estate data is received from a person that is the subject of the estate.

20. The system of claim 1, wherein the estate data is received from an entity associated with the estate.

21. A system comprising:
means for receiving estate data for an estate;
means for determining whether an entity is an allowable entity from access data for the estate data;
means for determining at least a portion of the estate data that the entity is authorized to access from the access data;
means for determining at least one access condition for the entity to access the at least the portion of the estate data from the access data;
means for determining whether the at least one access condition is met;
means for providing the entity access to the at least the portion of the estate data, if it is determined the entity is an allowable entity and the at least one access condition is met.
